(19) United States
(12) Patent Application Publication
(10) Pub. No.: US 2010/0106738 A1
(43) Pub. Date: Apr. 29, 2010

(54) SYSTEM AND METHOD FOR PROVIDING REPRESENTATION FOR PRO BONO OPPORTUNITIES

(75) Inventor: Alan W. Anderson, Highlands Ranch, CO (US)

Correspondence Address: MERCHANT & GOULD PC, P.O. BOX 2903, MINNEAPOLIS, MN, 55402-0903, US

(73) Assignee: Lanny, Inc. dba ProBonoUSA, Highlands Ranch, CO (US)

(21) Appl. No.: 12/525,777

(22) PCT Filed: Feb. 5, 2008
(86) PCT No.: PCT/US08/53068

§ 371 Date: Aug. 4, 2009

Related U.S. Application Data
(60) Provisional application No. 60/888,246, filed on Feb. 5, 2007.

(51) Int. Cl. G06F 17/30

(52) U.S. Cl. 707/769; 707/781; 707/E17.005; 707/E17.014

(57) ABSTRACT

The disclosure describes systems and methods for providing representation to pro se litigants or other pro bono opportunities. The system includes a central database of current pro bono opportunity information. Information to populate the database may be automatically retrieved from individual electronic sources, such as individual court dockets and court records' databases. Information may also be manually entered by attorneys, courts, legal aid societies, bar associations, law schools, legal clinics, law firms or from other sources. Through the interfaces provided by the system, an attorney may accept representation of a pro bono opportunity by directly communicating that to the system administrator. This may take the form of an electronic message, a click on a icon on a web page, or some other communication. In any case, this communication is sufficient to obligate the attorney to represent the pro bono opportunity, allowing representation to begin immediately upon such communication.

### RELATED APPLICATIONS

This application is being filed on 5 Feb. 2008, as a PCT International Patent application in the name of Alan W. Anderson, a U.S. citizen, applicant for the designation of all countries, and claims priority to U.S. Provisional Application No. 60/888,246, filed Feb. 5, 2007, which application is hereby incorporated by reference.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 illustrates an embodiment of a system for collecting pro bono opportunity information.

FIG. 2 illustrates an embodiment of a system displaying pro bono opportunity information to attorneys through which attorneys can accept representation of a pro bono opportunity.

FIG. 3 illustrates an embodiment of a method for providing representation to pro bono opportunities.

FIG. 4 illustrates an embodiment of a method of displaying pro bono opportunity information to an attorney in a client-server computing environment.

FIG. 5 illustrates an embodiment of a method of reserving a pro bono opportunity litigant.

FIG. 6 illustrates an embodiment of a web page showing the non-confidential information for a selected pro bono opportunity.

FIG. 7 illustrates an alternative embodiment of a web page showing the non-confidential information for a selected pro bono opportunity, in this case a pro se litigant opportunity, and a mechanism through which an attorney may agree to represent the litigants.

FIG. 8 illustrates an embodiment of a home page for a web-based pro bono opportunity system.

FIGS. 9A-9F illustrate an embodiment of a series of web pages that could be provided as part of a user interface to a search utility for searching the pro bono opportunity database.

FIG. 10 illustrates an embodiment of a web page providing a listing of search results generated in response to a user search for 8^{th} Amendment cases in the pro bono opportunity database as would be generated in response to the search illustrated in FIGS. 9A-9F.

FIG. 11 illustrates an embodiment a web page showing a summary of cases taken and reserved by a user.

FIG. 12 illustrates an embodiment of a warning page shown in response to a user selecting an accept representation element.

FIG. 13 illustrates an embodiment of a web page that could be provided as part of a user interface to a search utility for searching the pro bono opportunity database for non-litigation opportunities.

FIG. 14 illustrates an embodiment of a web page providing a listing of search results generated in response to a user search for 501(c)(3) cases in the pro bono opportunity database as would be generated in response to the search illustrated in FIG. 13.

FIG. 15 illustrates an embodiment of a web page providing the information for a specific pro bono opportunity selected from the listing shown in FIG. 14.

FIG. 16 illustrates an embodiment of a web page with an accept representation button displayed in response to a user selecting the reserve button illustrated in FIG. 15.

### PRO BONO REPRESENTATION

The representation of a party without expectation of a fee or at a reduced rate to the party is referred to as “pro bono” representation. Pro bono work is considered an ethical duty by the American and state bar associations and many law firms and solo practitioners perform significant amount of pro bono work each year. For the purposes of this disclosure, any unrepresented person or organization of limited means in search of pro bono legal representation will be referred to as a “pro bono opportunity.”

Pro se litigants are an example of one common type of pro bono opportunity. A pro se litigant is a party in a legal proceeding, such as a law suit, that is unrepresented by an attorney, either because the party does not wish to use an attorney or, more often, because the party cannot afford an attorney. For example, under 28 U.S.C. §1915(e), United States federal courts have the right to request that attorneys represent indigent and poor litigants in non-trivial lawsuits and other legal proceedings. This is a recognition that providing competent representation is a benefit to both the court and the litigants. One reason for this is because adjudicating legal proceedings involving a pro se litigant requires significantly more of a court's time and resources, as the court tries as much as possible to assist the pro se litigant with the process. In addition, the outcomes obtained by a pro se litigant are often not as good as those that could be obtained by a competent counsel, in some cases simply due to the pro se litigant's unfamiliarity with the court system and its processes.

Representing pro se litigants of limited means is one type of pro bono opportunity while providing pro bono legal services to individuals and organizations of limited means for issues not involved in litigation is another type of pro bono opportunity, for example, providing legal advice concerning contracts, consumer issues and landlord tenant disputes.

Applicable rules of Professional Conduct may define what legal services qualify as public service or pro bono representation. One example is the Colorado Supreme Court Pro Bono Legal Services Recognition Program. For example, under the Colorado rules, pro bono opportunities include any services defined in the Colorado Rules of Professional Conduct (C.R.P.C.) 6.1 Comment, Recommended Pro Bono Policy for Colorado Licensed Attorneys and Law Firms, Section III (which reference is hereby incorporated herein by reference), which addresses: A. Representation of Low Income Persons; B. Civil Rights and Public Rights Law; C. Representation of Charitable Organizations; D. Community Economic Development; E. Administration of Justice in the Court; F. Law-Related Education; and G. Mentoring of Law Students and Lawyers on Pro Bono Matters. In some circumstances, attorneys who perform qualifying pro bono legal services may receive credits toward the attorney's obligation to obtain continuing legal education. Often, pro bono opportunities as defined herein will qualify as pro bono work under rules of professional conduct. However, some pro bono opportunities may not meet the requirements as a Pro Bono Legal Service in their jurisdiction. Attorneys, in many circumstances and for many different reasons, may still be interested in the pro bono representation of such qualifying pro bono opportunities.

In spite of the courts' and bar associations' efforts to motivate attorneys to take on pro bono work, many pro bono opportunities are unable to find adequate representation because of several factors. First, there is no easy way for attorneys to know, at any given time, who is in need of representation. Currently, attorneys may be introduced to pro se litigants and other pro bono opportunities in need of representation in many different ways. For example, attorneys may be contacted directly by a pro bono opportunity looking for representation. As another example, attorneys may be contacted by a court requesting that the attorney take on a particular pro se litigant of limited means as a pro bono case. In other cases, attorneys seeking to do pro bono work may actively search for pro se litigants by monitoring court dockets and periodically making inquires. Other types of pro bono opportunities are even harder to find and typically can only be identified by networking with organizations.

Second, many attorneys prefer to undertake only specific types of pro bono cases; or prefer to undertake cases only before certain judges, courts or geographic areas. This can make it difficult to match willing attorneys with pro bono opportunities, especially in light of the haphazard way in which attorneys learn of pro bono opportunities.

Third, even when a pro se litigant or other pro bono opportunity is found that meets an attorney's requirements, another problem arises with the conflict of interest issues surrounding representing multiple parties. Attorneys are governed by a set of ethics rules that require that an attorney refuse to represent any party if the representation of that party would inhibit the attorney's ability to represent an existing client. If such a conflict arises between two clients of an attorney, the ethics rules require that the attorney cease representing both clients in the matter. In order to ensure that law firms and attorneys do not accept a new client that is or may become adverse to an existing client, an extensive conflict check is often performed. Such a check must be done prior to accepting representation and entering into an attorney-client relationship. Conflict checks typically require that a significant amount of information about the nature of the case and parties involved be obtained. As the conflict rules make no distinction between the type of party being represented or whether such representation is pro bono representation, before an attorney undertakes the representation of a pro se litigant all the normal conflict checks are typically performed. This is an added difficulty because often the information necessary to perform a conflict check on a pro bono opportunity must be manually retrieved from court records or obtained personally from the litigant or potential client, thus requiring a significant amount of time and money on the attorney's part each time an attorney wishes to determine if a pro bono opportunity would conflict with representation of an existing client.

These factors are disincentives for attorneys who wish to represent pro bono opportunities. In addition, it means that the community of clients in need of pro bono representation is not as well served as it could be.

### Detailed Description of Systems and Methods for Providing Representation for Pro Bono Opportunities

Against this backdrop, systems and methods for providing representation for pro bono opportunities have been developed. The systems and methods create and maintain a central database of current pro bono opportunity information. Information to populate the database may be automatically retrieved from individual electronic sources, such as individual court dockets and court records' databases. Information may also be manually entered or otherwise provided by attorneys, courts, legal aid societies, bar associations, law schools, legal clinics, law firms or from other sources.

The database contains searchable records associated with each pro bono opportunity and includes information in sufficient detail for an attorney to easily find those pro bono opportunities that meet the attorney's preferred criteria. The database further includes or provides access to information in sufficient detail for an attorney to perform a conflict check by identifying existing and potential adverse parties to the pro bono opportunity. Thus, the attorney can search for potential pro bono opportunities and immediately obtain the necessary information to perform a conflict check on any identified pro bono opportunities.

The system further includes several other features adapted specifically to the needs of the pro bono attorney. In an embodiment, an attorney may undertake representation of a pro bono opportunity by directly communicating that to the system administrator. This may take the form of an electronic message, a click on a button on a web page, or some other electronic communication through the user interfaces of the system. In any case, this communication is acceptance of the representation of this pro bono opportunity and obligates the attorney to the pro bono opportunity (i.e., the pro se litigant or potential client in need of pro bono legal services), so that representation begins immediately upon such communication. After accepting the representation, the attorney may then be able to access additional confidential information in the database related to the pro bono opportunity, such confidential information not being accessible prior to the acceptance of the representation.

The system may further allow an attorney to reserve a pro bono opportunity, such as while the attorney completes a conflict check. When reserved, information about the reserved pro bono opportunity may still be viewable by other attorneys, but no other attorney may undertake representation through the system until the reservation is removed by the reserving attorney.

For example, in one aspect the disclosure describes a computerized method for providing representation for pro bono opportunities. The method includes identifying one or more pro bono opportunities, including a first opportunity, in which each pro se opportunity being a party seeking pro bono legal advice. For each pro bono opportunity, the method includes collecting non-confidential information including information regarding adverse parties and stores that information in a database. The non-confidential information in the database is made accessible to at least one attorney which includes displaying, to the at least one attorney, at least some of the non-confidential information and a first user-selectable element associated with the first opportunity. The first user-selectable element, which may be a button on a web page, upon selection by a selecting attorney confirms that the selecting attorney has accepted representation of the first opportunity.

The disclosure also describes a method of accepting representation of a party. The method includes displaying a web page of information about one or more unrepresented parties to one or more attorneys. Via interaction with the web page such as by clicking on a button associated with an unrepresented party, a viewing attorney can agree to represent one or more of the unrepresented parties.

The disclosure further describes a system for providing representation to pro bono opportunities. The system includes a pro bono opportunity database containing information associated with a plurality of pro bono opportunities, in which each pro bono opportunity is an unrepresented party in need of pro bono legal services. The systems also includes a pro bono opportunity display module that, in response to a request from an attorney, displays at least some of the information associated with the plurality of pro bono opportunities to the attorney and further displays an instrumentality whereby the attorney may accept representation of at least one pro bono opportunity. The instrumentality may be a button, hyperlink to a series of web pages, or some other user interface element through which the attorney can communicate to the pro bono opportunity system administrator that the attorney has accepted representation of the pro bono opportunity.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the methods and implementation of the systems described herein. The benefits and features of the systems and methods will be realized and attained by the structure particularly pointed out in the written description and claims hereof as well as the appended drawings.

It is to be understood that both the foregoing general overview and the following more detailed description are exemplary and explanatory and are intended to provide further explanation of the invention as it is defined in the claims.

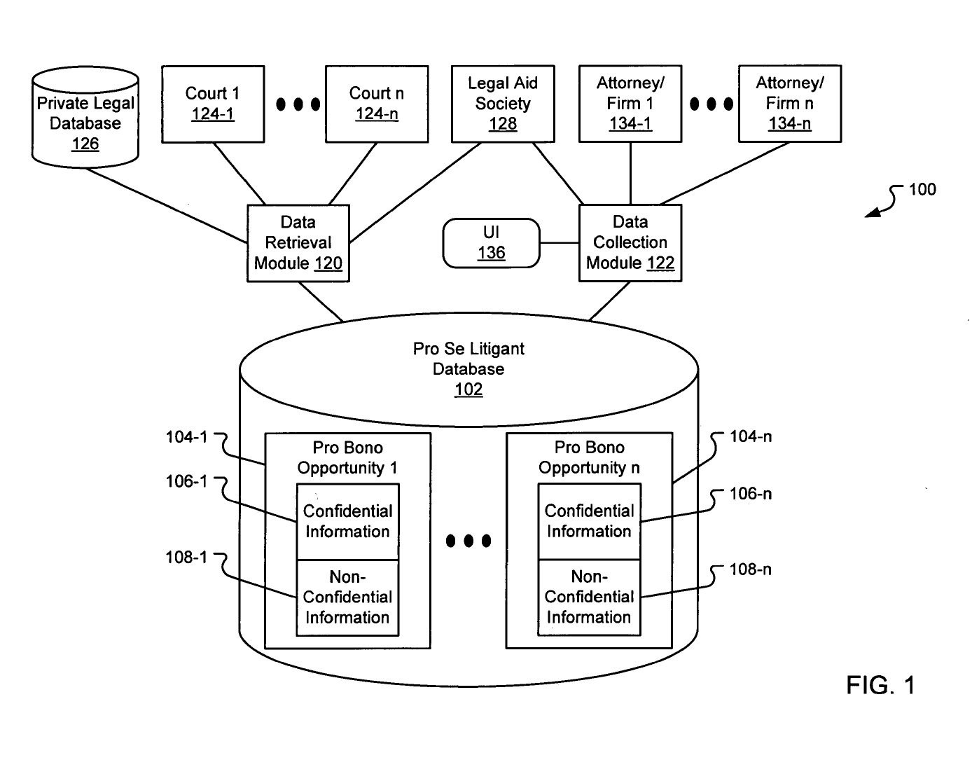

FIG. 1 illustrates an embodiment of a system for collecting pro bono opportunity information. For the purposes of the remaining description, the term “pro se litigant” refers to those unrepresented litigants of limited means that are either seeking pro bono representation or that are under a court-ordered request for representation, such as under 28 U.S.C. §1915(e) described above. As described above, a pro se litigant represents just one type of pro bono opportunity. Although the majority of following disclosure will focus on the example of providing representation to pro se litigants, the reader will understand that the systems and methods described herein could be equally adapted to providing representation for any pro bono opportunity.

The system 100 includes a database 102 containing pro bono opportunity information. The database 102 includes information 104 associated with each litigant. In an embodiment, the information 104 about each litigant and the litigant's case may be divided into two types, confidential information 106 (if any) and non-confidential information 108. As discussed in greater detail below, access to a litigant's confidential information 106 is restricted so that only an attorney that has agreed to represent a particular litigant can access the litigant's confidential information 106.

In the embodiment shown, the database 102 may be populated with information from external sources by a data retrieval module 120 and a data collection module 122. Additionally, a manual entry module (not shown) may be provided so that the database administrator may directly input new information into the database 102.

The data retrieval module 120 actively retrieves new and updated pro bono opportunity information from remote sources such as electronic court dockets, public legal databases, etc. The data retrieval module 120 is adapted to search for new and/or changed pro bono opportunity information 106, 108, retrieve that information, modify or transform it as necessary to match the information format used in the pro bono opportunity database 102, and store the information in the database 102.

In the embodiment shown, the data retrieval module 120 is adapted to retrieve pro bono opportunity information from the electronic systems of a number of courts 124. In addition, the data retrieval module 120 may be adapted to retrieve pro bono opportunity information 106, 108 from a pay-per-use legal database 126, such as the PACER system operated by the federal court system and the legal proceeding databases operated by Lexis-Nexis or Westlaw. Information may also be retrieved from databases or systems 128 operated by non-profit legal aid societies, law schools, charities, etc. The data retrieval module 120 may be connected to the various entities by a direct connection, by a private network or by a public network such as the internet.

When retrieving pro bono opportunity information, the data retrieval module 120 may retrieve all pro bono opportunity information available from the remote data source 124, 126, 128 or some predefined subset of available information. If the information retrieved includes confidential information 106 and non-confidential information 108, the different types of information are flagged and stored appropriately so that only non-confidential information 108 can be accessed except by attorneys representing the litigant.

The data collection module 122 receives pro bono opportunity information from external sources, such as individual attorneys or law firms 134, or from legal aid societies 128 or other entities 128 involved with or assisting pro bono opportunities in obtaining representation. In many circumstances, pro se litigants and other clients in need of pro bono representation first attempt to obtain representation by contacting individual attorneys, law firms or charity organizations such as a legal aid society or clinic serving the indigent population. Through the data collection module 122, if the initially contacted attorney or party declines to represent the pro bono opportunity, the pro bono opportunity's information 106, 108 may be input into the database 102. This effectively publishes the existence of pro bono opportunity to all attorneys using the system and therefore increases the chance of the pro bono opportunity to obtain representation quickly. Depending on the party providing the pro bono opportunity information to the data collection module 122, there may be no confidential information 106 to be provided.

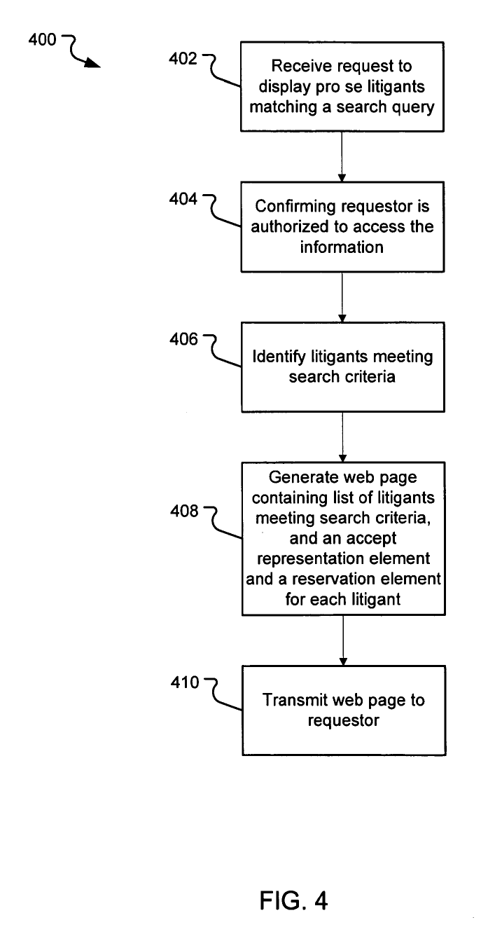

In the embodiment shown, the data collection module 122 collects data via a user interface (UI) 136. The UI 136 may be a web site, web page or other interface page or pages that are displayed to assist in the entry of pro bono opportunity information. In order to ensure the quality of the information provided, only authorized parties may be allowed to enter data through the data collection module 122 and different levels of authorization may be associated with different information entry and access capabilities. Authorization of pro bono opportunity information providers may be handled similar to the authorization of attorneys as described with reference to FIG. 4, below. In an alternative embodiment, the data collection module 122 may accept pro bono opportunity information directly from any party seeking pro bono representation, such as via kiosks placed in court clerks' offices. The data collection module 122 may be connected to the various entities by a direct connection, by a private network or by a public network such as the internet.

The modules and components described above may be implemented in different manners depending upon the needs of the system. For example, in an embodiment the data retrieval module 120, the data collection module 122, and the database 102 may be implemented on a single computer (not shown). In this embodiment, the data retrieval module 120 and data collection module 122 may be embodied in one or more software applications that are stored in the computer's memory and independently executed on the computer's processor. The database 102 may be embodied by a file storage structure in which the pro bono opportunity information is stored on a data storage device such as a hard disk drive or flash memory on or accessible to the computer. In an alternative embodiment, the functions of one or more of the modules 120, 122, 102 may be divided between different computers, databases or computing devices. For example, in an embodiment the database 102 may be maintained and managed by a separate database server that interacts with one or more server computers which perform the functions of the other modules 122, 120 operated by the system manager. Furthermore, different databases may be provided for different types of pro bono opportunities to facilitate management of the information. For example, in an embodiment a pro se litigant database may be maintained independently of a general pro bono opportunity database containing information about non-litigation opportunities.

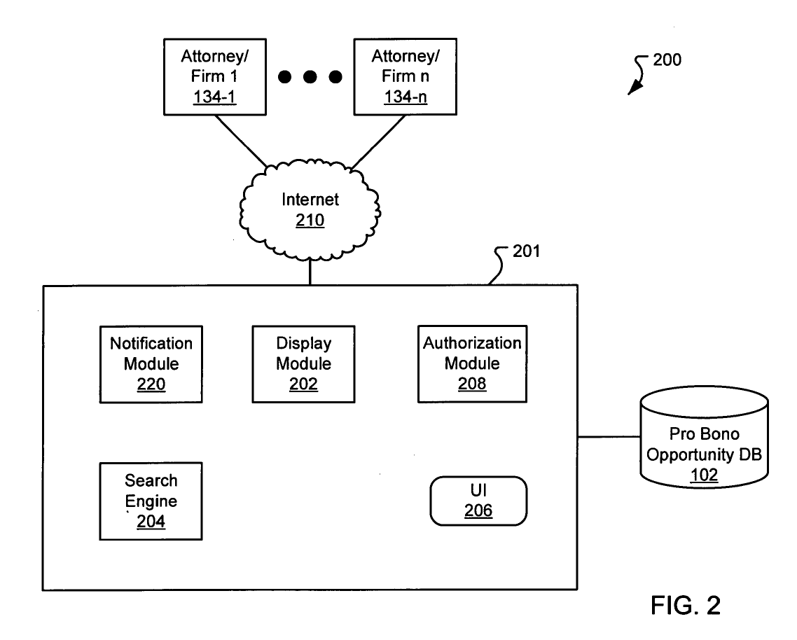

FIG. 2 illustrates an embodiment of a system displaying pro bono opportunity information to attorneys and through which attorneys can select and accept representation of a pro bono opportunity. In the embodiment shown, attorneys, law firms or other parties 134 electronically access a central pro bono opportunity information display system 201 via a network 210 such as the Internet as shown. In an embodiment, each attorney/party 134 may use a computer executing a browser or other application through which the display UI 206 of the display system 201 may be viewed.

The display system 201 further includes a display module 202 that receives requests from authorized attorneys 134 and, in response, retrieves pro bono opportunity information from the database 102 and displays it to the requestor 134. In the embodiment shown, the display module 202 displays the pro bono opportunity information via a display UT 206. The display UT 206 may take the form of a web page or pages that are generated and transmitted to the requestor 134 in response to a search query or other request for information. Through the display UI 206 the results of the search query or other request are displayed to the viewing attorney or party 134.

Web pages associated with the display UT 206 may also contain information and links that are of special interest to pro bono attorneys and other seeking pro bono opportunities. For example, links to experts, interpreters, interested law students, volunteers, and court reporters that wish to do pro bono work may be provided.

The display system 201 is further provided with a search engine 204 that can process search queries from a requesting attorney and generate a set of results matching the terms of the search query. For example, an attorney may search for pro se litigants that have cases before a specific court by entering a search query for that court. The search engine 204 then searches the database 102 for pro se litigants in that court and return a listing of pro se litigants matching the query. As another example, an attorney may search for pro opportunities that involve specific areas of law (e.g., tax law, employment law, etc.) or that involve specific types of clients (e.g., charity organization, non-profit organizations, indigents, etc.). This listing or other results set from the search engine may then be formatted by the display module 202 into the format required by the UT 206 and displayed to the requesting attorney.

The display system 201 may be provided with an authorization module 208. In an embodiment, the authorization module may perform several functions. One function is limiting any access to the pro bono opportunity database 102 to authorized users only. Access may also be limited based on the type of access. For example, some attorney-users may be authorized to view and accept representation of a pro bono opportunity identified by the display module 202. Authorized non-attorney users may be authorized only to view the non-confidential pro bono opportunity information. In addition, some users may be authorized only to input pro bono opportunity information through the data collection module 122 as discussed in reference to FIG. 1, in which case the authorization module 208 may also be used when collecting information from third parties.

Another function of the authorization module 208 is to prevent confidential information of pro bono opportunities from be accessed by parties that do not represent that the litigants. In this aspect, in response to a request for confidential information for a specified litigant or party the authorization module 208 determines if the requestor is currently the attorney (or working on behalf of the attorney) that is representing the litigant or party. If so, then the request is permitted and the confidential information may be accessed. If not, then the request is denied.

In an embodiment, the system 200 allows attorneys to have alerts or notifications automatically generated when pro bono opportunities matching specific criteria are entered into the database 102. For example, such notifications may be provided by email, text message or pre-recorded audio telephone call. Such notification functionality may be performed by an alerting module (not shown) and obviates the need for attorneys in search of opportunities matching specific criteria to periodically recheck the database for new matching cases. The notification functionality is illustrated in FIG. 2 via the notification module 220.

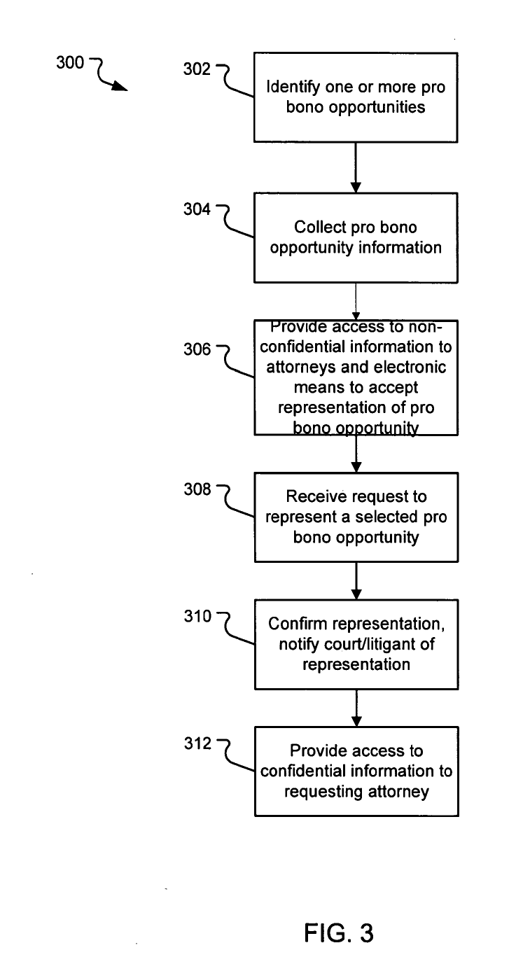

FIG. 3 illustrates an embodiment of a method for providing representation to pro se litigants or other pro bono opportunities. In the embodiment, the method 300 first identifies one or more pro bono opportunities in an identification operation 302. The identification operation 302 may include retrieving new pro bono opportunity information from remote databases and other legal proceeding information sources as described above. In addition, the identification operation 302 may include receiving pro bono opportunity information submitted by the party seeking pro bono representation or submitted by authorized third parties such as attorneys, law firms, legal aid societies, courts, etc. through a data collection module as described above.

Regardless of the source of the pro bono opportunity information, the information is collected and stored in an information collection operation 304. In the information collection operation 304, the format of the information may be modified in order to make it conform to the format of the pro bono opportunity database. For example, in an embodiment the pro bono opportunity information is parsed into predetermined data fields and stored in a relational database. Thus, different fields may be provided for each data element, e.g., name, address, court, docket number, case type (prisoner rights, land-lord tenant, breach of contract, consumer protection, affirmative action, small claims, child custody, wills and trusts, discrimination, etc.), specific court dates (such as dates for different hearings, pleadings, etc.), contact information, recommended experience level of attorney, non-confidential case description, adverse parties, related parties and confidential facts and other information. The number and type of data fields selected may differ depending on the type of case, court, etc. Such fields may contain the information or, in an alternative embodiment, may contain links to the information. For example, an additional facts field may contain links files in a court database related to the case.

Depending on the type of opportunity, different fields may be shown. For example, for pro se litigants one field that may be shown is a field indicating whether the pro se litigant has been instructed by the court to obtain representation and who instructed the litigant to do so. As discussed above, this is within a court's power and this information may be particularly useful to attorneys attempting to screen pro se litigants for ones whose case is of particular importance to a court.

Another type of field that may be important when displaying information about pro se litigants is a case status field. This data field contains information concerning the current status of the case, e.g., motion to dismiss in summary judgment pending or denied, trial date set, etc.

In an embodiment, pro se litigant information may not be collected unless and until a case has progressed past some specified point in the legal process. For example, in an embodiment only information on pro se litigants that have survived the initial motion to dismiss based on summary judgment are collected and entered into the database. This acts as a screening tool so that only litigants with meritorious cases are presented to attorneys.

The collected information is then made accessible to authorized attorneys and other authorized members of the pro bono community in a first provide access operation 306. In an embodiment, the first provide access operation 306 includes displaying non-confidential pro bono opportunity information to any authorized requestor in order that the requestor may evaluate the litigant and run any necessary conflict checks. For example, in a client-server embodiment an attorney may use a browser on the attorney's computer to retrieve web pages from a server hosting the pro bono opportunity web site. Through the web pages of the web site, the attorney is provided access to the non-confidential information in the pro bono opportunity database. In an alternative embodiment, registered users of the pro bono opportunity system may periodically be sent listings of available pro bono opportunities or notified of litigants matching the attorney's preset criteria, such as via email in periodic messages, which may contain or through which the recipient can access the non-confidential information.

In addition, the provide access operation 306 also includes providing some instrumentality/mechanism for a viewing attorney to accept the representation of a litigant/party by affirmatively agreeing to represent/accepting representation of the litigant. As described in greater detail below, the mechanism may be a user-selectable element (e.g., a button, hyperlink or other user-selectable element displayed on a web page) for each litigant displayed on a user interface that accepts the representation of that pro bono opportunity. In an embodiment, selection of the element causes an electronic message to be sent to the system confirming that the attorney wishes to represent the associated litigant. In an alternative embodiment, the mechanism may be a user-selectable element that redirects the requestor to another web page or interface through which the requestor may agree to represent the associated litigant. Alternatively, a communication may be transmitted to the user, such as via email or fax, through which the user can effect representation by following the instructions on the communication. In yet another embodiment, the accepting attorney may be instructed to call a specified phone number through which the attorney can enter or provide information to an automated system to complete the acceptance of the representation.

In the embodiment shown, a receive representation request operation 308 is illustrated. The receive representation request operation 308 occurs when an attorney uses the mechanism, e.g., selects the accept representation button, to agree to represent a litigant as described above. The receive representation request operation 308 may include transmitting a prompt to the requestor, such as an “Are you sure?” prompt, which reminds the requestor that acceptance will begin the attorney's representation of the litigant and ethically obligate the attorney to the litigant.

In response to receiving the confirmation that the requestor wishes to represent the litigant, a confirm representation operation 310 is performed. The confirm representation operation 310 may transmit a confirmation message to the requestor confirming that the pro bono opportunity will be removed from the database, that the requestor is now representing the litigant, and alerting the requestor to any important upcoming dates or actions that must be performed. The confirmation message may also provide contact information for the litigant and access information, such as a password or docket number, through which the requestor may obtain access to any confidential information related to the litigant.

The confirm representation operation 310 may also include automatically transmitting various notifications, such as messages to the court database, the court's administrator and/clerk, the judge assigned to the case, to the litigant and to any other related or interested party (e.g., the party that transmitted the pro bono opportunity's information to the pro bono opportunity database or the opposing counsel). Such notifications may include the representing attorney's name and contact information, which may be retrieved from the attorney's registration or account information obtained when the attorney registered for the pro bono opportunity service.

The method 300 may also provide a representing attorney access to any of the pro bono party's confidential information contained in the pro bono opportunity database. This is illustrated by the second provide access operation 312. In an embodiment, attorneys may be registered to use the pro bono opportunity service via a username and password and the second provide access operation 312 may simply revise the data currently accessible by the attorney to include the confidential information for the represented litigant(s). The operation 312 may also include providing the representing attorney with information on how to access the confidential information for the selected litigant. Such information may include identification of a special URL or other web page through which the information may be accessed.

FIG. 4 illustrates an embodiment of a method of displaying pro se litigant information to an attorney in a client-server computing environment. In the embodiment shown, an attorney uses a browser on a computer to access a web portal for the pro se litigant system and display information from the system on the attorney's computer. The portal, for example through the use of web pages, allows the attorney to perform such actions as initiate a search for pro se litigants, view non-confidential information about pro se litigants, log in to the attorney's account in order to access confidential and non-confidential litigant information for the litigants the attorney represents and manage the attorney's preferences.

In the embodiment shown, the method 400 starts with the request from an attorney to display a current list of pro se litigants in need of representation. This is illustrated by the receive request operation 402. Such a request may include first identifying that the requestor is interested only in display pro bono opportunities that are pro se litigants. The request may be a simple request to list all pro se litigants or, as illustrated, may take the form of a search request in which the attorney provides one or more search terms or search criteria in the faun of a search query. For example, the request may be a request to display pro se litigants with a specified type of case and in which the legal proceeding is in a particular court. In an embodiment, the search request may be created by the attorney's interaction with a search UI, such as a search entry web page, through which the attorney may select and/or enter search criteria. Such search entry web pages and UIs through which search criteria and search queries may be entered are known in the art and any such UI may be adapted for use herein.

If it has not already been done, the method then confirms that the requestor is authorized to access the pro bono opportunity database in a verify authorization operation 404. In an embodiment, viewing access to pro se litigant information may be limited to only attorneys, law firms or other attorney delegates (e.g., administrative assistants, secretaries, paralegals) acting on behalf on an attorney or law firm. This may require the user to log in to the system, such as via a user name and password, as is known in the art.

For example, in an embodiment an attorney must first register with the pro bono opportunity service. Registration may include payment of a subscription fee and the attorney providing sufficient information to verify that the registrant is licensed to practice law. In addition, registration may include identifying what jurisdiction each attorney is licensed to practice so that the system may limit all information displayed (either automatically or by request of the registrant) to only those jurisdictions. Registration may also include obtaining contact information from the attorney. Upon registration, an attorney may be provided with a username and password, which is then used to identify the attorney to the system and verify the level of access that the attorney should be accorded in requests or access sessions.

Registration may also include obtaining the registrant's agreement as to the terms and conditions of use of the pro bono opportunity information. For example, in an embodiment a registrant may be required to read and agree to a policy regarding contacting pro bono opportunities and the ramifications of accepting representation via the web site's mechanism. For example, the attorney may be required to agree that the attorney is obligated to follow up with each pro bono opportunity accepted via the web site's mechanism.

If the request is authorized, the pro se litigants matching the search criteria are determined in an identify matching litigants operation 406. This operation 406 identifies a list of pro se litigants to be provided as the results of the request.

In the embodiment shown, a generate web page operation 408 is then performed in which one or more search results web pages are created that contains some or all of the list of pro se litigants. The amount and type of information shown on the search results web page may be determined by the system operator or by default display options selected by the searching attorney. For example, in an embodiment, the first 10 pro se litigants in the search results may be displayed on an initial web page in which the litigants are listed alphabetically by last name and showing, such as in a tabular format, the litigant's name, case type, adverse parties and proceeding venue.

The web page generated may automatically display any conflict information (i.e., information important in the performance of a conflict check) known, in addition to the adverse party. In an alternative embodiment, a user-selectable element such as a button may be provided with the results that, upon selection, causes some or all of the conflict information to be displayed. For example, the adverse party may be automatically displayed for all results and if there is additional conflict information for a particular pro se litigant a “see additional conflict information” button may be provided for that litigant.

The web page may further be provided with a user-selectable element for each pro se litigant that displays additional non-confidential details and documents (e.g., complaints, reports, exhibits, answers, etc.) related to the legal proceeding. In an embodiment, details may be textual descriptions of the facts of the case entered by a court clerk, legal aid clinic worker, or some other party that initially provided the pro se litigant's information to the pro bono opportunity database.

The generate web page operation 408 further may include generating a web page that contains at least one user-selectable element, such as a push button, radio button, hyperlinked icon, hyperlinked text, data entry field, etc., through which the attorney may accept representation of a pro bono opportunity. Continuing the example from above, next to each listing of a pro se litigant, the web page may include a separate button with the text “represent this litigant/party” that, upon selection by the viewing attorney, initiates the representation of that party as described above. In an embodiment, the representation element may only be displayed to the viewer after all information relevant to the pro se litigant in the database has been displayed to the viewer.

In an embodiment, the web page may also include a reservation button that reserves the pro se litigant for some period of time (or, alternatively, until the reserving attorney either represents the litigant or releases the reservation by declining to represent the litigant). As described above, reserving a litigant allows an attorney to run a conflict check within the attorney's law firm and otherwise gives the attorney time to get approval without the attorney having to worry that representation of the litigant will be taken on by another attorney during the interim. Depending on how the system operator implements the system or the search being performed, reserved litigants may or may not be listed in results of attorney searches. However, if reserved litigants are included in pro se litigant search results, such reserved litigants are appropriately marked and viewers will not have the ability to accept representation of an opportunity currently reserved by another attorney.

The ability to reserve an opportunity also allows an attorney time to contact and interview the parties involved. To facilitate such contact between attorneys and potential pro bono parties, a contact element may be provided on the web page that generates an email to the party or parties involved. Alternatively, each listing could include the parties contact information in order to facilitate contact by the attorney. Note that the terms of agreement of the pro bono opportunity system may require that attorneys who find opportunities via the system use the system's mechanism to retain the opportunities in order to accurately monitor how successful the system is in matching attorneys to pro bono opportunities.

After the web page(s) have been generated, a transmit web page operation 410 transmits the web page (or the initial page if there are more than one) to the attorney's computer for display to the attorney. The attorney can then navigate through the results and, if desired, reserve or agree to represent one or more of the pro se litigants in the search results.

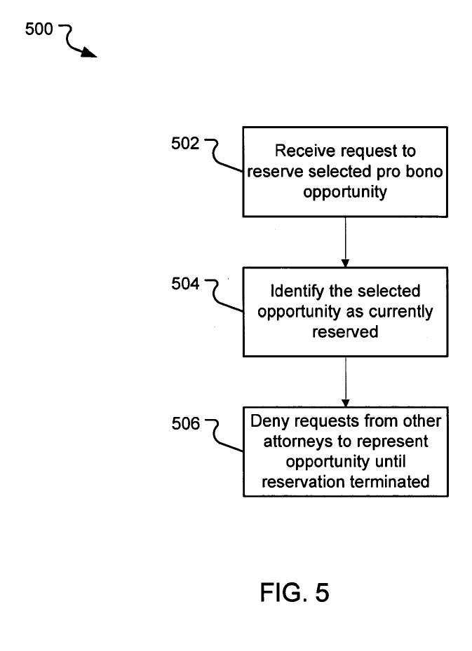

FIG. 5 illustrates an embodiment of a method of reserving a pro bono opportunity. In the embodiment, an attorney has requested that the pro bono opportunity system reserve a litigant or other pro bono opportunity. This is illustrated by the receive request operation 502. In an embodiment, the request may be generated by a viewing attorney selecting a reserve litigant element, e.g., by pressing on a reserve litigant button next to a litigant or party in a listing of pro bono opportunities. From the generated request, the system can determine which attorney is making the request and which pro bono opportunity the attorney has selected and wishes to reserve.

In response to the litigant reservation request, the system flags the selected pro bono opportunity as currently reserved in a status change operation 504. This may include changing a data field in the database to indicate that the pro bono opportunity is reserved as opposed to currently available. The system may further record which attorney has reserved the litigant and information from which the system can identify when such a reservation will expire, if ever.

In addition, upon receipt of a reservation request the system denies any requests to represent a reserved litigant until the reservation terminates in a denial operation 506. As discussed above, reserved litigants may or may not be listed in search results generated after the reservation request has been received. However, if reserved litigants are included in pro bono opportunity search results, such reserved litigants are appropriately marked and viewers will not have the ability to accept representation of reserved litigants.

In an alternative embodiment (not shown), an attorney may be able to agree to represent a pro bono opportunity in the event that the reserving attorney chooses not to represent that litigant. In such a situation, the attorney that reserved the litigant may be notified that another attorney wishes to represent the reserved litigant and prompt the reserving attorney to release his reservation or represent the litigant.

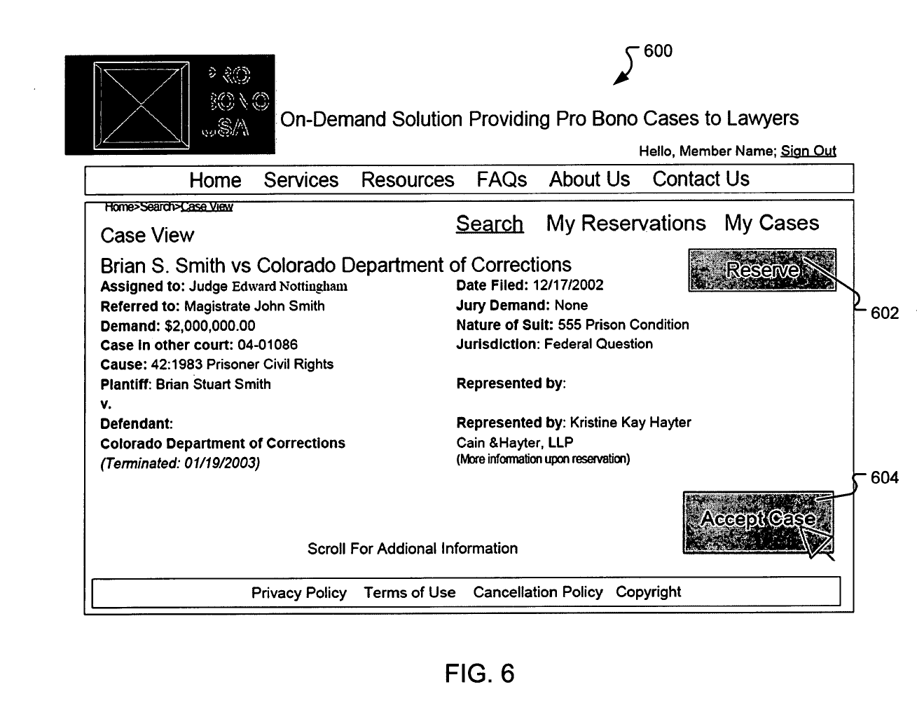

FIG. 6 illustrates an embodiment of a web page showing the non-confidential information for a selected pro bono opportunity, in this case a pro se litigant, and a mechanism through which an attorney may agree to represent the litigants. In the embodiment shown, in addition to the non-confidential information that allows the viewer to conduct a conflict check, a user-selectable button element 602 is provided for reserving the opportunity as well as a user-selectable button element 604 that, if selected, causes the viewing attorney to accept representation of the pro se litigant shown, in this case Mr. Smith.

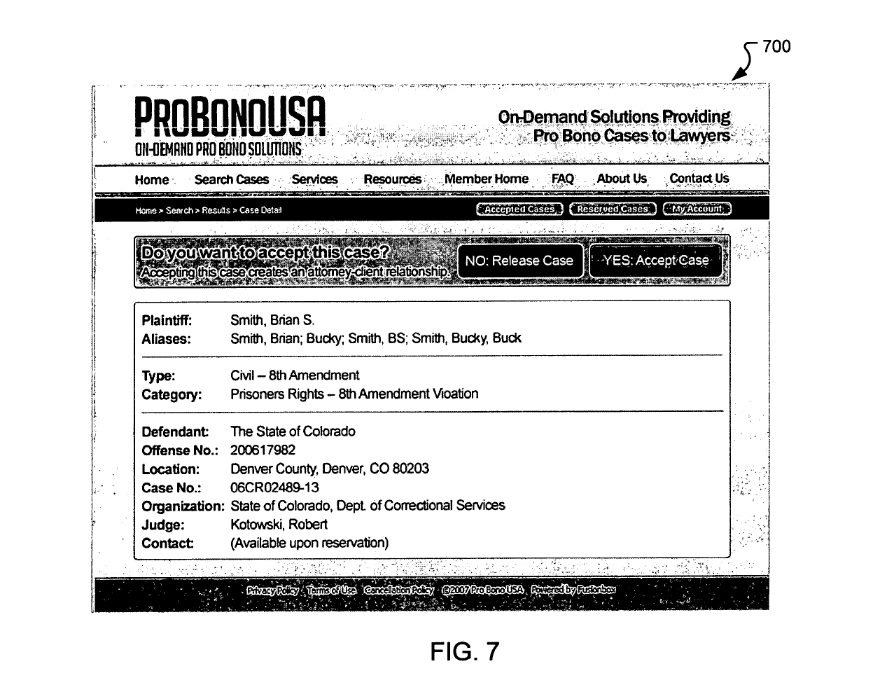

FIG. 7 illustrates an alternative embodiment of a web page showing the non-confidential information for a selected pro bono opportunity, in this case a pro se litigant opportunity, and a mechanism through which an attorney may agree to represent the litigants.

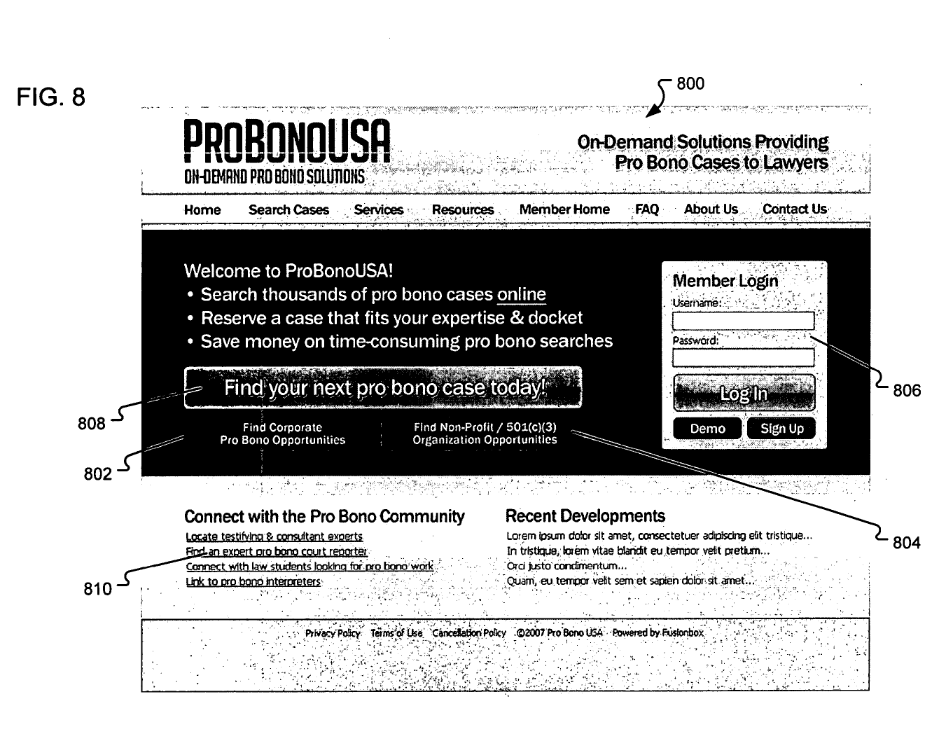

FIG. 8 illustrates an embodiment of a home page for a web-based pro bono opportunity system. The home page 800 includes a first user-selectable element 802 for accessing a database of non-litigation corporate pro bono opportunities and a second user-selectable element 804 for accessing a database of non-profit/501(c)(3) pro bono opportunities. In addition, there are text boxes comprising a member login element 806. Another element 808 is also provided that accesses a general search page for searching all the pro bono opportunities. A set of links 810 are also provided to experts, volunteers and other legal industry service providers that may have an interest in supporting pro bono work.

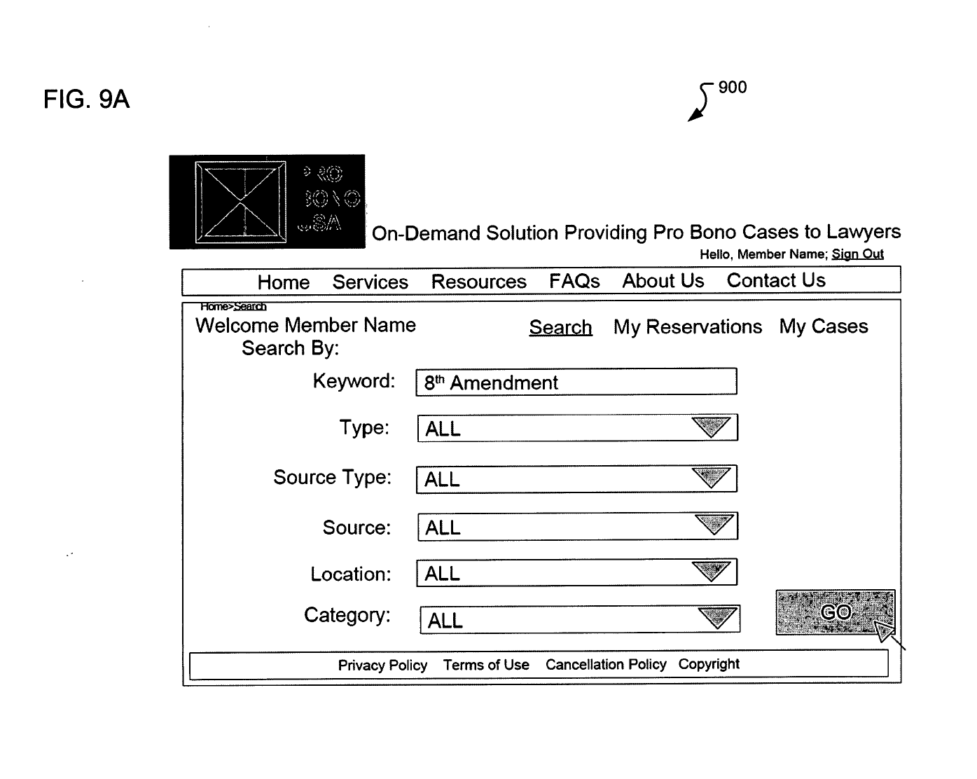

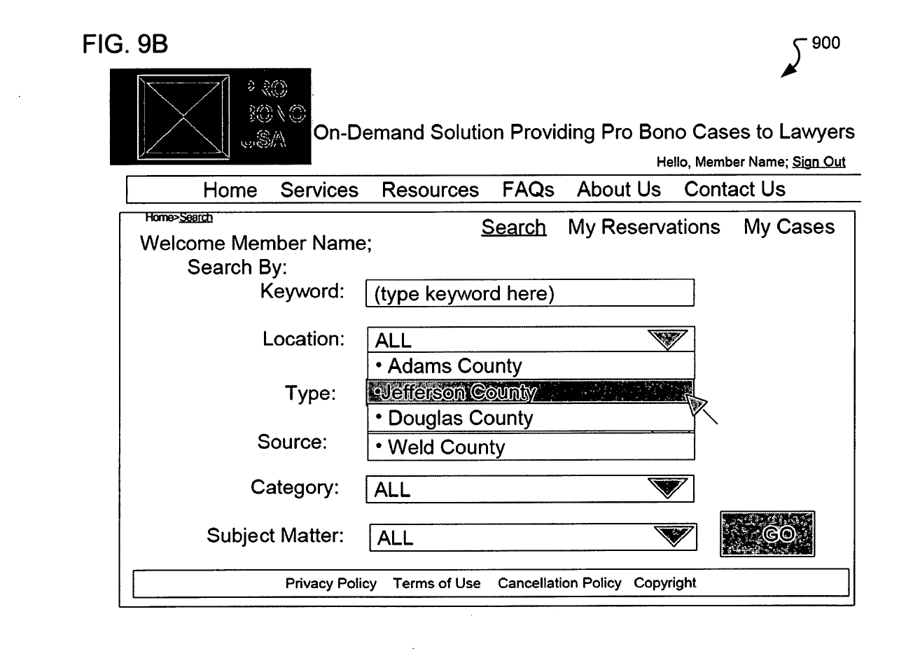

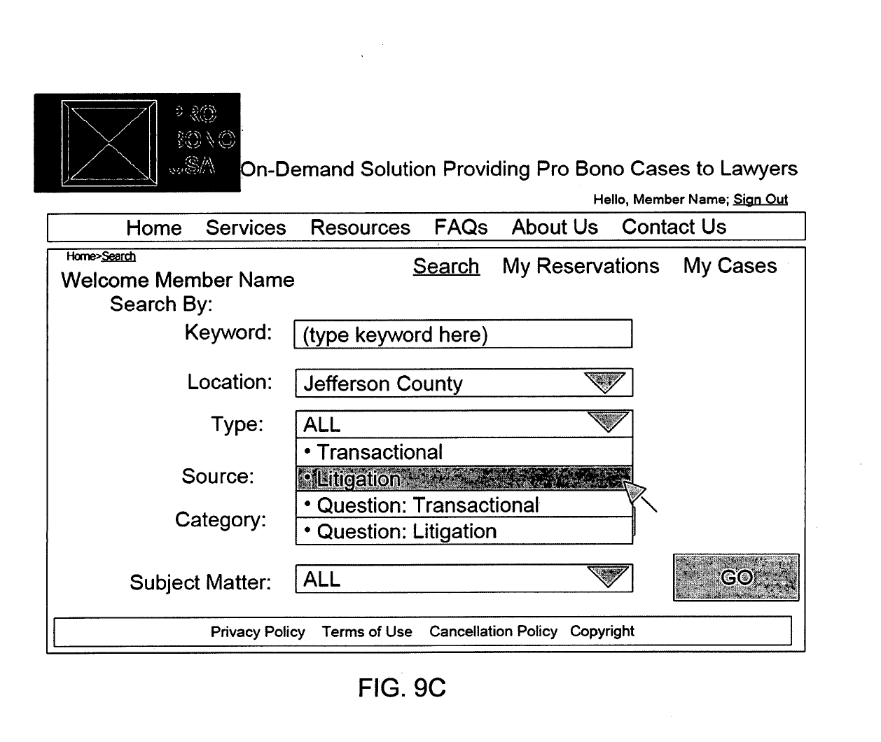

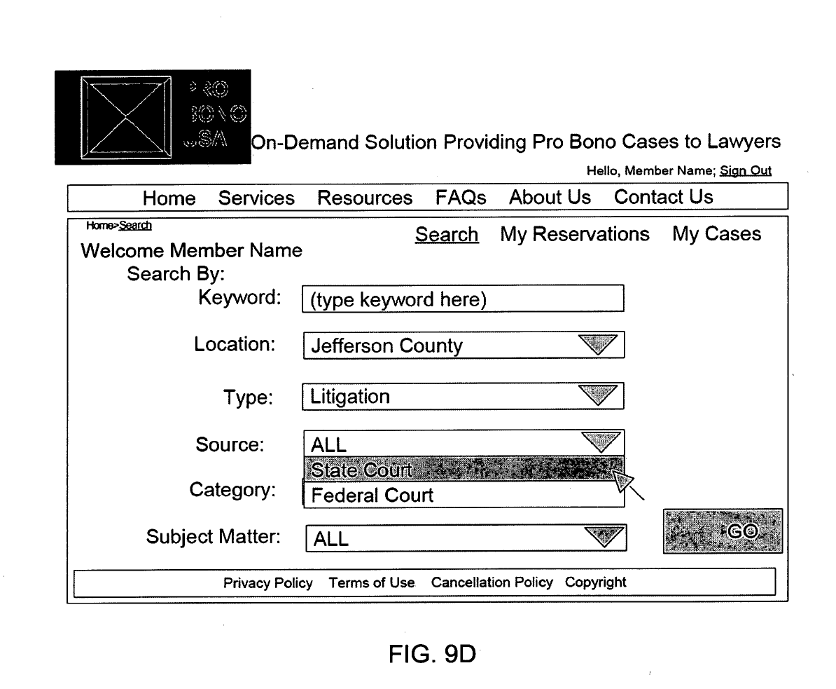

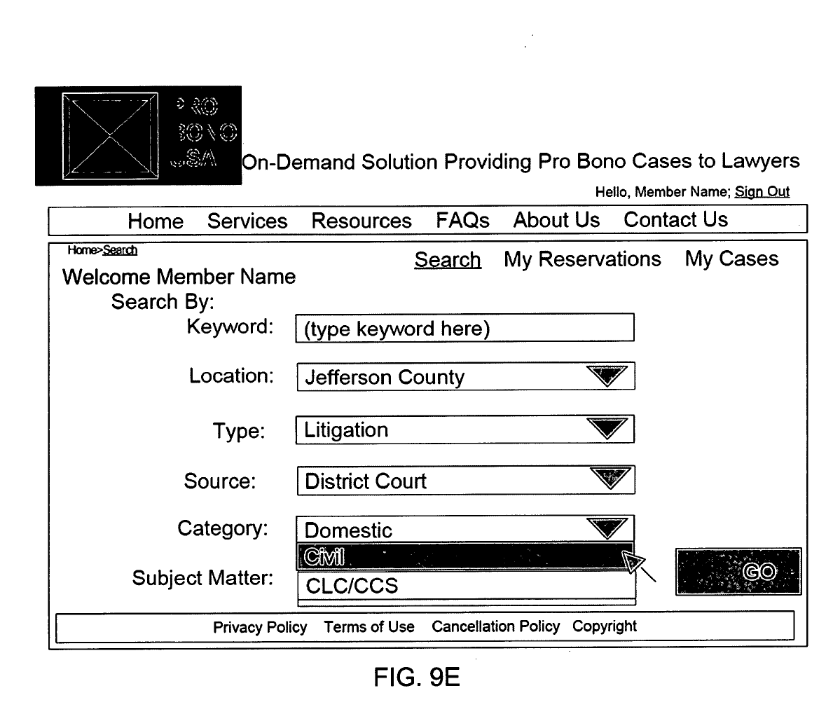

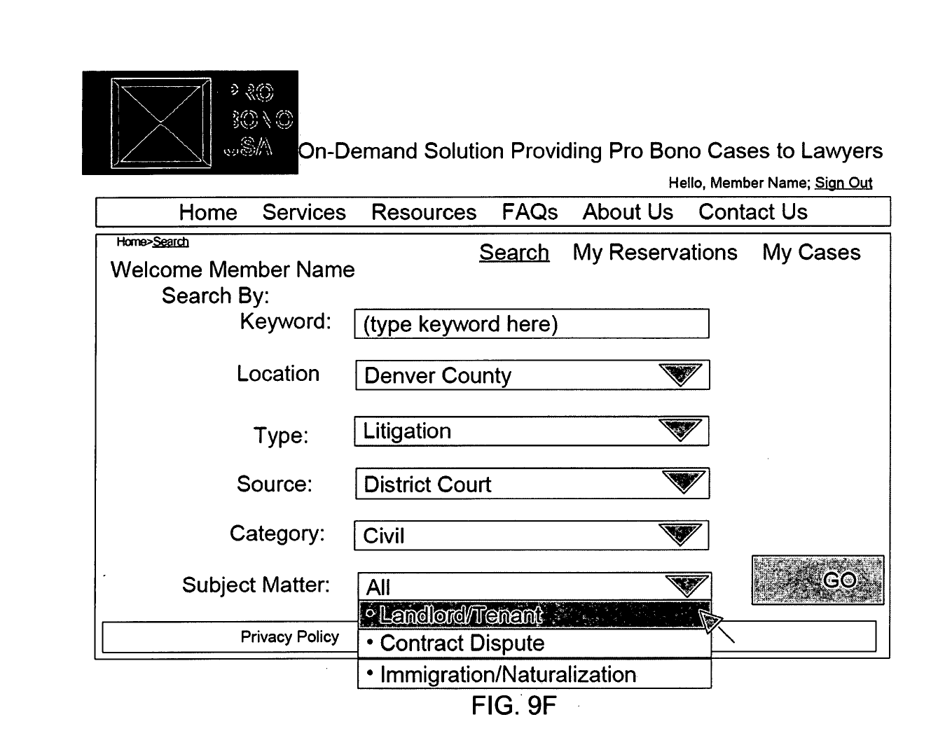

FIGS. 9A-9F illustrate an embodiment of a series of web pages that could be provided as part of a user interface to a search utility for searching the pro bono opportunity database. The web pages shown are directed to search for pro se litigants and show the data fields for that type of pro bono opportunity. In the series of web pages illustrated, the user utilized drop down boxes to make selections to narrow the search to cases of interest to the user.

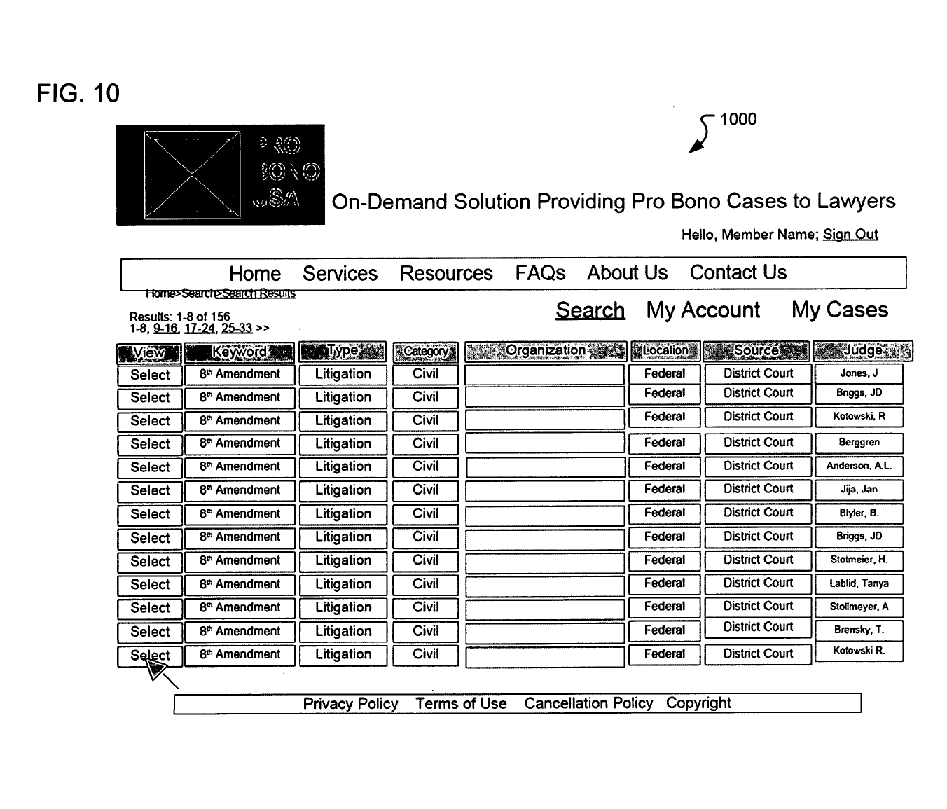

FIG. 10 illustrates an embodiment of a web page providing a listing of search results generated in response to a user search for 8^{th} Amendment cases in the pro bono opportunity database as would be generated in response to the search illustrated in FIGS. 9A-9F.

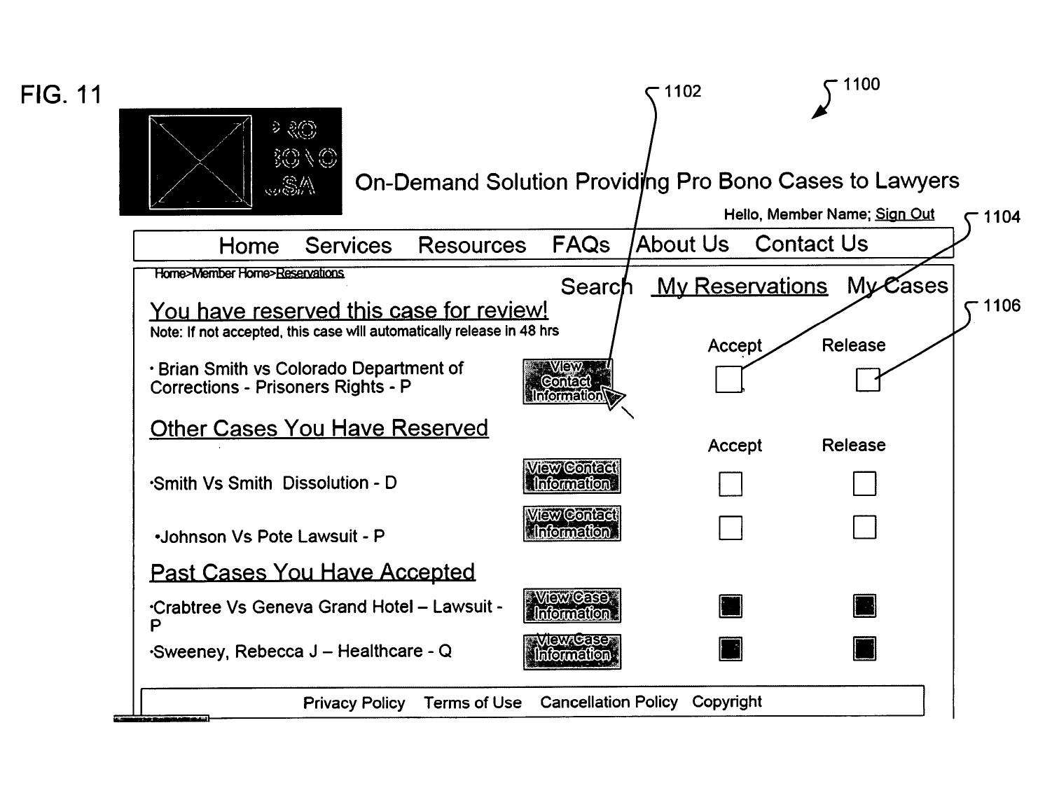

FIG. 11 illustrates an embodiment a web page showing a summary of cases taken and reserved by a user. In the embodiment, a user-selectable button element 1102 is provided through which the user can obtain contact information for an associated party displayed in the listing. A check box element 1106 is provided through which a user may release a reserved opportunity. In addition, a second check box element 1104 is provided through which a user may accept representation of a reserved opportunity, thus initiating the representation of the associated pro bono opportunity.

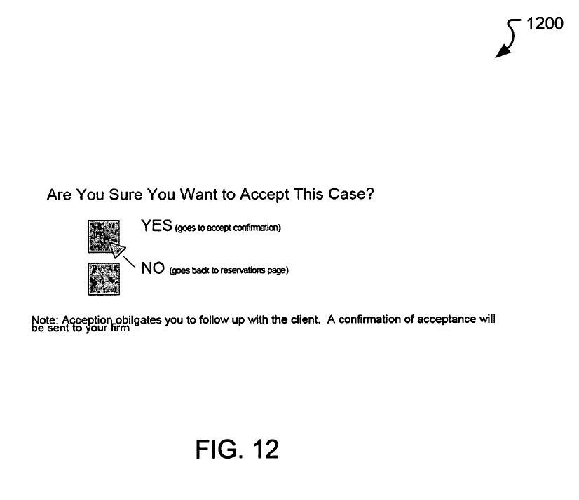

FIG. 12 illustrates an embodiment of a warning page shown in response to a user selecting an accept representation element.

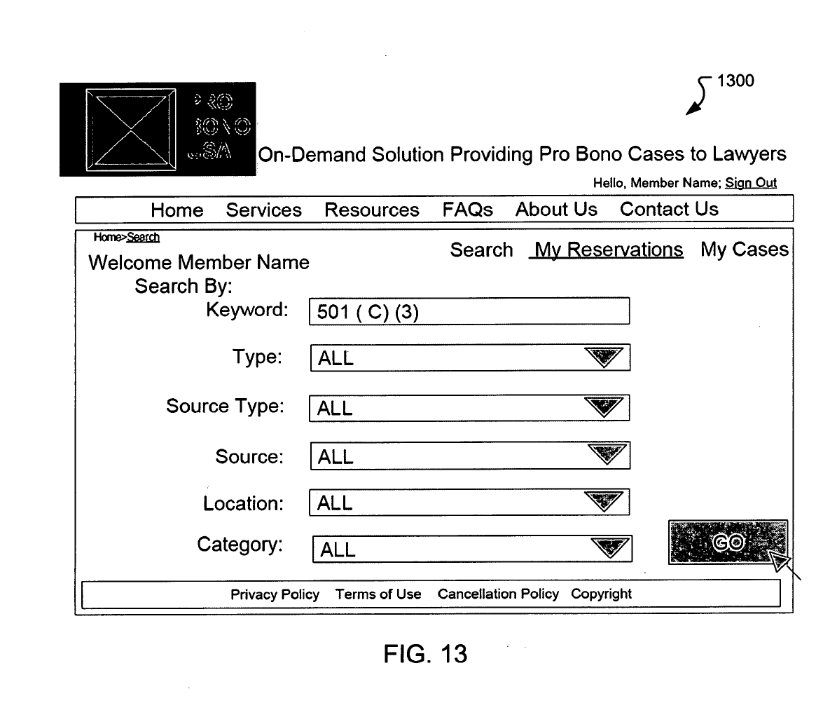

FIG. 13 illustrates an embodiment of a web page that could be provided as part of a user interface to a search utility for searching the pro bono opportunity database for non-litigation opportunities.

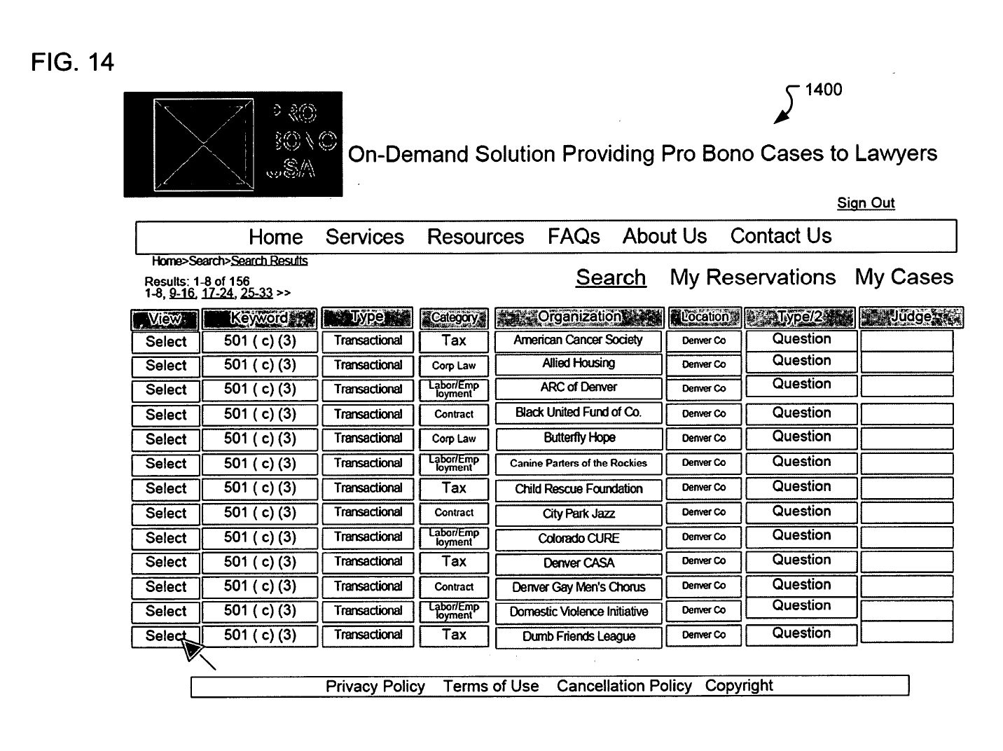

FIG. 14 illustrates an embodiment of a web page providing a listing of search results generated in response to a user search for 501(c)(3) cases in the pro bono opportunity database as would be generated in response to the search illustrated in FIG. 13.

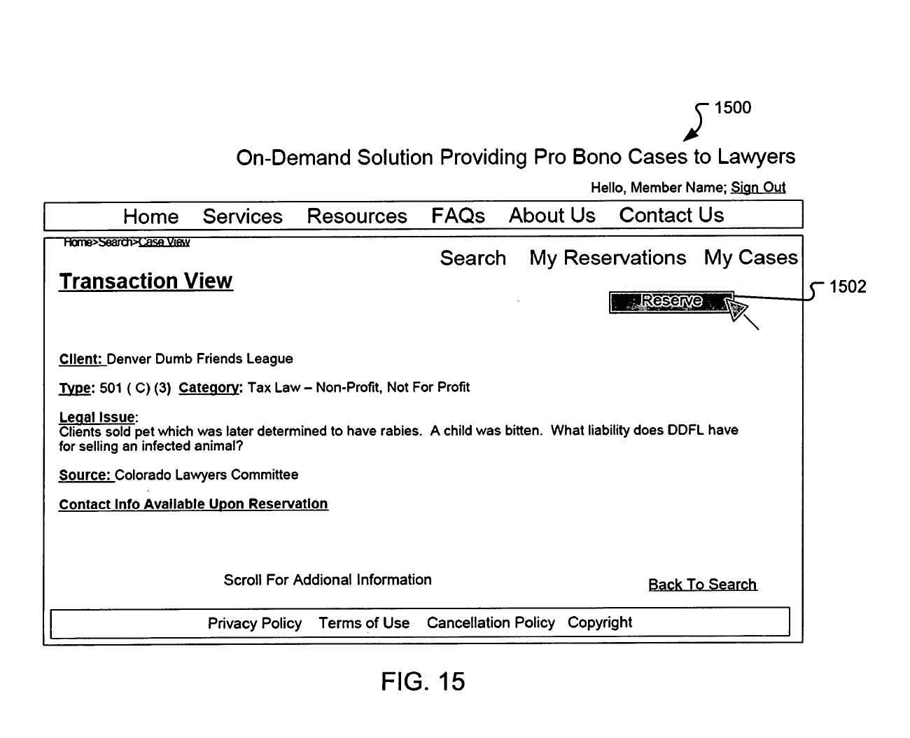

FIG. 15 illustrates an embodiment of a web page providing the information for a specific pro bono opportunity selected from the listing shown in FIG. 14. In the embodiment shown, the user must reserve the opportunity before the user is shown a web page from which the user can accept the opportunity and initiate representation of the pro bono opportunity.

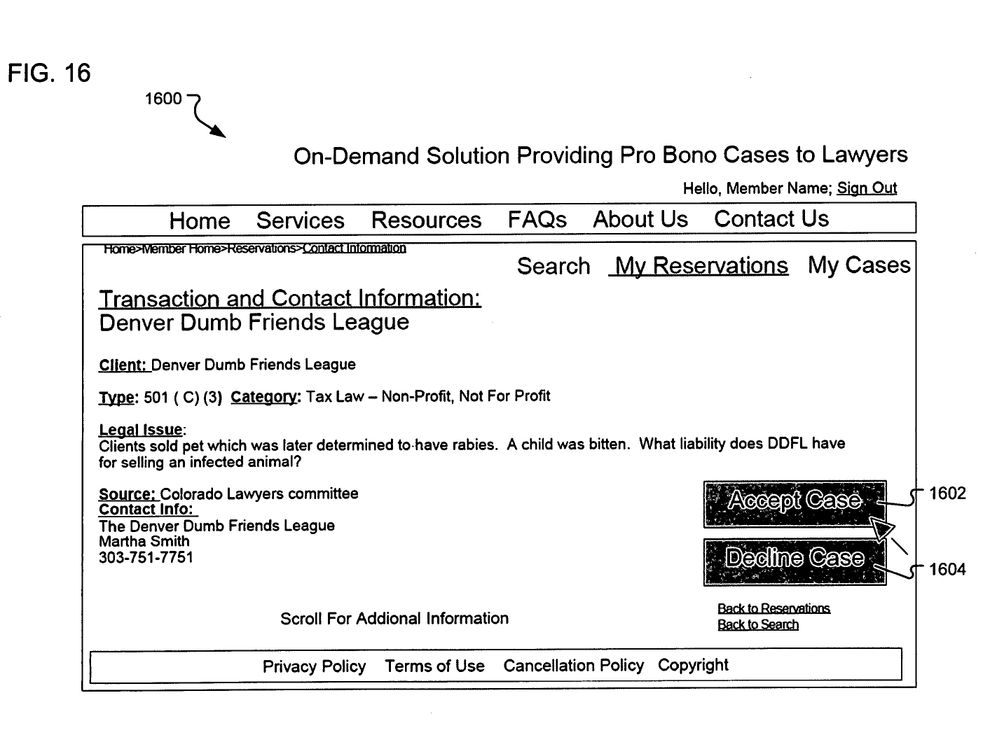

FIG. 16 illustrates an embodiment of a web page displayed in response to a user selecting the reserve button illustrated in FIG. 15. In the embodiment shown, the user now can accept the opportunity by selecting the accept representation button 1602. Alternatively, the user may release the reservation by selecting the decline and release reservation element 1604.

It will be clear that the pro bono opportunity representation systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible. Additionally, alternative embodiments of methods described herein may be created by combining or reordering the various steps and operations described.

While various embodiments have been described for purposes of this disclosure, various changes and modifications may be made which are well within the scope of the present invention. For example, the system could be adapted for use in a public defender's office allowing public defender's to search for cases of a particular type or matching selected criteria. Numerous other changes may be made which will readily suggest themselves to those skilled in the art and which are encompassed in the spirit of the invention disclosed and as defined in the appended claims.

1. A computerized method for providing representation for pro bono opportunities comprising:
identifying a plurality of pro bono opportunities, including a first opportunity, each pro se opportunity being a party seeking pro bono legal advice;
for each pro bono opportunity, collecting non-confidential information in a database, the non-confidential information including information regarding adverse parties;
providing at least one attorney access to the non-confidential information in the database; and
displaying, to the at least one attorney, at least some of the non-confidential information and a first user-selectable element associated with the first opportunity, wherein the first user-selectable element, upon selection by a selecting attorney, confirms that the selecting attorney has accepted representation of the first opportunity.

2. The method of claim 1, wherein the first opportunity is a pro se litigant and selection of the first user selectable element obligates the selecting attorney to represent the pro se litigant.

3. The method of claim 2, wherein the pro se litigant is an unrepresented party in a legal proceeding before a court wherein the court has requested that an attorney volunteer to represent the party in the legal proceeding and the method further comprises:
displaying, to the at least one attorney as part of the displayed non-confidential information, information indicating whether the pro se litigant has been instructed by a court to obtain representation.

4. The method of claim 1 wherein providing access to non-confidential information further comprises:
displaying, to the at least one attorney, a list of pro bono opportunities, the list containing only non-confidential information associated with the pro bono opportunities which are not represented by an attorney or a law firm at the time the list is displayed; and
upon receiving a request for more information on a selected pro bono opportunity, displaying all non-confidential information associated with the selected pro bono opportunity.

5. The method of claim 1 further comprising:
displaying, to the at least one attorney, a second user-selectable element associated with the first opportunity that, upon selection by a selecting attorney, reserves the first opportunity;
in response to a selection of the second user-selectable element, changing a status of the pro bono opportunity from available to currently reserved;
in response to a selection of the second user-selected element, displaying the associated opportunity within the list of pro bono opportunities as currently reserved; and
displaying, to the at least one attorney, an accept representation element associated with each pro bono opportunity in the list, wherein selection of an accept representation element obligates the selecting attorney to represent the associated pro bono opportunity.

6-8. (canceled)

9. The method of claim 1 further comprising:
receiving a search request for a list of pro bono opportunities matching search criteria;
determining, based on the non-confidential information and the search criteria, a set of pro bono opportunities that match the search criteria; and
displaying the set of pro bono opportunities matching the search criteria.

10. The method of claim 2 further comprising:
in response to a selection of the first user-selectable element, notifying a court associated with the pro se litigant that the selecting attorney has accepted representation of the pro se litigant.

11. The method of claim 1 wherein collecting confidential information further comprises:
automatically retrieving the non-confidential information from at least one database of legal proceedings information.

12. The method of claim 1 further comprising:
in response to a request from a party to enter pro bono opportunity information associated with a pro bono opportunity into the database, confirming that the party is authorized to enter pro bono opportunity information; and
displaying to the party a pro bono opportunity data entry page through which the pro bono opportunity information is entered into the database.

13. The method of claim 1 wherein the non-confidential information for each pro bono opportunity includes at least one of a name of a party associated with the pro bono opportunity, a type identifier associated with the type of pro bono legal service sought by the party, a court assigned to the pro bono opportunity, a judge assigned to the pro bono opportunity, a court docket number, an adverse party name, a field indicating whether the pro se litigant has been instructed by a court to obtain representation, and a date associated with the pro bono opportunity.

14. A method of accepting representation of a party comprising:
displaying a web page of information about one or more unrepresented parties to one or more attorneys, wherein, via interaction with the web page, a viewing attorney can agree to represent one or more of the unrepresented parties.

15. The method of claim 14 further comprising:
displaying, via the web page, sufficient information about each unrepresented party necessary to determine if representing the unrepresented party would conflict with the viewing attorney's representation of the viewing attorney's existing clients;
displaying, to the one or more attorneys, a reservation element associated with each unrepresented party, wherein selection of a reservation element prevents other attorneys from agreeing to represent the associated unrepresented party via the web page;
displaying, to the one or more attorneys, at least one accept representation element associated with an unrepresented party, wherein selection of an accept representation element confirms that the selecting attorney has accepted representation of the accept representation element's associated party.

16-17. (canceled)

18. A system for providing representation to pro bono opportunities comprising:
a pro bono opportunity database containing information associated with a plurality of pro bono opportunities, each pro bono opportunity being an unrepresented party in need of pro bono legal services;
a pro bono opportunity display module that, in response to a request from an attorney, displays at least some of the information associated with the plurality of pro bono opportunities to the attorney and further displays an instrumentality whereby the attorney may accept representation of at least one pro bono opportunity.

19. The system of claim 18 further comprising:
a data retrieval module that retrieves information associated with pro bono opportunities from at least one court-operated remote database and stores the retrieved information in the pro bono opportunity database.

20. The system of claim 18 further comprising:
a first authorization module that determines if an attorney transmitting the request to the pro bono opportunity display module is authorized to view the requested information.

21. The system of claim 18 further comprising:
a data collection module through which information associated with a plurality of pro bono opportunities is received from an attorney and stored into the pro bono opportunity database.

22. The system of claim 21 further comprising:
a second authorization module that determines if a party from whom the information is received is authorized to provide the information.

23. The system of claim 18 further comprising:
a computer having a processor and memory, the processor executing software thereby causing the computer to perform the functions of the pro bono opportunity display module.

24. The system of claim 17, wherein the pro bono opportunity database contains information about pro se litigants.

25. The system of claim 17, wherein the pro bono opportunity database contains information about non-litigation pro bono opportunities.
